(19) United States
(12) Patent Application Publication
(10) Pub. No.: US 2024/0193227 A1
(43) Pub. Date: Jun. 13, 2024

(54) COMPRESSION OF SPARSE MATRICES FOR VECTOR PROCESSING

(71) Applicant: Xilinx, Inc., San Jose, CA (US)

(72) Inventors: Abhishek Kumar Jain, Indirapuram (IN); Dinesh Gaitonde, Fremont, CA (US)

(73) Assignee: Xilinx, Inc., San Jose, CA (US)

(21) Appl. No.: 18/076,602

(22) Filed: Dec. 7, 2022

(51) Int. Cl. G06F 17/16; G06F 7/50; G06F 7/523; G06F 7/544

(52) U.S. Cl. CPC G06F 17/16; G06F 7/50; G06F 7/523; G06F 7/5443

(57) ABSTRACT

Partition-level compression of an m×n sparse matrix includes determining in each partition, row and column indices of elements having non-zero values. Each partition has s rows and t columns and s<m and t<n. A group of ordered sets of tuples is generated from the elements and row and column indices in each partition that has at least one non-zero element. Each ordered set includes s tuples, and positions of the s tuples in the ordered set correspond to the s rows of the partition, each tuple includes a value of an element of the partition and an associated column index, and the associated column index indicates, for an element of the partition having a non-zero value, a column index in the partition. A compression processor indicates for each group, a count of the one or more ordered sets, a partition row number, and a partition column number.

### TECHNICAL FIELD

The disclosure generally relates to compression of sparse matrices.

### BACKGROUND

Matrix multiplication is an integral function in digital signal processing and in machine learning neural networks. In multi-layer networks, matrix multipliers can be connected in a chain, with output vectors of one matrix multiplier being the input vectors to the next matrix multiplier. Some systems implement parallel matrix multiplier circuitry in an attempt to speed processing. Though parallel matrix multiplier circuitry can improve performance, movement of data between random access memory (RAM) resources and on-chip hardware accelerator memory can limit throughput and involve significant circuit and computing resources.

Matrix multiplication in digital signal processing and in neural networks often involves sparse matrices. A sparse matrix is a matrix having a large proportion of zero values relative to non-zero values. A common computation is multiplication of a sparse matrix by a dense vector.

Prior approaches aimed at improving performance involve intelligent sparsification of neural network data models. Intelligent sparsification can reduce computation and memory bandwidth requirements without sacrificing too much accuracy. However, sparsity in the data models introduces challenges in designing an efficient system due to irregularity and extra complexity in the execution.

### SUMMARY

A disclosed method includes determining in each partition of a plurality of partitions of an m×n matrix by a compression processor, row and column indices of elements having non-zero values, wherein each partition has s rows and t columns and s<m and t<n. The method includes generating, by the compression processor, a group of one or more ordered sets of tuples from the elements and row and column indices in each partition of the plurality of partitions that has at least one non-zero element. Each ordered set includes s tuples, and positions of the s tuples in the ordered set correspond to the s rows of the partition, each tuple includes a value of an element of the partition and an associated column index, and the associated column index indicates, for an element of the partition having a non-zero value, a column index in the partition. The method includes indicating by the compression processor, for each group of one or more ordered sets of tuples, a count of the one or more ordered sets, a partition row number, and a partition column number.

A disclosed circuit arrangement includes first register circuitry configured to store t elements of an input vector and a control circuit. The control circuit is configured to input a sequence of one or more value vectors and a sequence of one or more column-index vectors. Each value vector has s elements of a partition of a plurality of partitions of an m×n matrix. The partition has s rows and t columns, each element of the value vector corresponds to a row of the partition, and s<m and t<n. Each column-index vector is associated with a value vector in the sequence of one or more value vectors, and each column-index vector has s elements associated with the s elements of the associated value vector, respectively. The circuit arrangement includes a selection circuit configured to select s elements in parallel from the first register circuitry in response to values of the s elements of and in-process column-index vector of the sequence of one or more column-index vectors. The circuit arrangement includes a plurality of s multiplication circuits configured to generate s products in parallel from the s elements selected from the first register circuitry and the s elements of the value vector associated with the in-process column-index vector. The circuit arrangement includes a plurality of s accumulation circuits configured to accumulate s sums in parallel from the s products, respectively. Each sum of the s sums is a sum of the products generated in response to like-indexed elements in the sequence of one or more value vectors and like-indexed elements in the sequence of column-index vectors.

Another disclosed circuit arrangement includes a plurality of vector processors configured to multiply a compressed sparse matrix by an input vector having n elements. The compressed sparse matrix represents an m×n sparse matrix and the compressed sparse matrix includes for one or more partitions of a plurality of partitions of the sparse matrix, a respective sequence of one or more value vectors and one or more associated column index vectors. Each value vector has s elements of a partition of the plurality of partitions, and each column-index vector has s elements associated with the s elements of the associated value vector, respectively. Elements of each value vector correspond to rows of the partition, and each partition has elements of a group of s rows and t columns of the sparse matrix, and s<m and t<n. Each vector processor is configured to generate in parallel for a partition of the plurality of partitions, s products of elements of a value vector of the one or more value vectors and elements selected from t elements of the input vector according to column index values in the associated column-index vector of the one or more column-index vectors. Each product is associated with a row of the partition. Each vector processor is configured to Each vector processor is configured to generate in parallel for a partition of the plurality of partitions, s respective partial sums of the products associated with the s rows of the partition. For each group of s rows of the sparse matrix, a vector processor of the plurality of vector processors is configured to generate s final sums from the s respective partial sums.

Other features will be recognized from consideration of the Detailed Description and Claims, which follow.

### BRIEF DESCRIPTION OF THE DRAWINGS

Various aspects and features of the methods and systems will become apparent upon review of the following detailed description and upon reference to the drawings in which:

FIG. 1 illustrates an exemplary system that can compress a sparse matrix and compile an application to configure vector processors to multiply the compressed sparse matrix by a vector;

FIG. 2 illustrates an exemplary system having an array of data processing engines (DPEs) that can be configured to multiply compressed sparse matrix(s) by an input vector(s) for various applications;

FIG. 3 shows an example of a sparse matrix A, a dense vector X, and a vector Y that is the result of multiplying the sparse matrix by the dense vector;

FIG. 4 shows an example of a sparse matrix compressed into groups of ordered sets of tuples;

FIG. 5 shows a flowchart of an exemplary algorithm for compressing a sparse matrix into groups of ordered sets of tuples;

FIG. 6 shows the vectors associated with the example of FIG. 4;

FIG. 7 shows the partial multiplication of compressed sparse matrix by an input vector;

FIG. 8 shows an exemplary vector processor and an input sequence of value vectors and column-index vectors;

FIG. 9 shows an exemplary mapping of partitions of a sparse matrix to an array of vector processors;

FIG. 10 shows examples of different mappings of the MAC processing associated with a sparse matrix having 16 partitions; and

FIG. 11 shows a flowchart of exemplary processes of generating programming data to simulate or configure a target device to multiply a sparse matrix by an input vector.

### DETAILED DESCRIPTION

In the following description, numerous specific details are set forth to describe specific examples presented herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element.

The disclosed methods and systems can be used in various applications in which sparse matrices are multiplied by dense vectors. For brevity, in this description a sparse matrix may be simply referred to as a “matrix,” and a dense vector may be simply referred to as an “input vector. According to the disclosed approaches, a matrix is partitioned and each partition is compressed. The manner of compression reduces memory and bandwidth requirements, reduces computational requirements, and increases throughput through parallel processing by multiple vector processors.

The processing associated with the partitions can be mapped onto multiple vector processors, each of which can perform multiple multiply-and-accumulate (MAC) operations in parallel. Once partitioned, configuration data can be generated to program a network to select the correct data from the input vector for each MAC operation. Partitioning the weights across multiple vector processors also means that weights can often be stored entirely on-chip, avoiding the need to load weights from external memory during runtime.

According to the disclosed compression scheme, an m×n matrix is divided into multiple s×t partitions. The number of columns, t, in each partition can be less than the number of columns, n, of the matrix to enable the input vector to be divided and spread across the local memory of multiple vector processors. The number of rows in each partition can be selected to match the number of MAC operations a vector processor can perform in parallel.

The compression entails pairing values of non-zero elements of the partition with the column index of the element within the partition, and grouping the pairings into ordered sets of pairings. Each pairing is a tuple that includes a value and column index, and the position of each tuple in the order corresponds to the row of the value in the partition. Each ordered set of tuples includes at least one non-zero element from the partition, and each ordered set includes s tuples. The partitions of a matrix can have different numbers of ordered sets of tuples if there is no regular pattern of sparsity between partitions. Some partitions may have 0 ordered sets of tuples, and other partitions may have t ordered sets of tuples. An ordered set can have one or more tuples having a 0-value partition element where there no non-zero elements in a row, or all the non-zero elements in a row are paired in other ordered sets, because each ordered set has tuples for s rows of a partition.

According to a particular approach, each group of tuples can be stored as a value vector and an associated column index vector, each of length s. The values in each value vector are the values of the partition elements in the tuples of the ordered set, and the index of each value in the value vector corresponds to the position of the tuple in the ordered set, which is the partition row of the elements. The values in each column index vector are the partition column indices of the corresponding (same vector index) values in the value vector. The disclosed compression scheme implicitly encodes the row indices of the non-zero elements by the position of the elements in the value vectors.

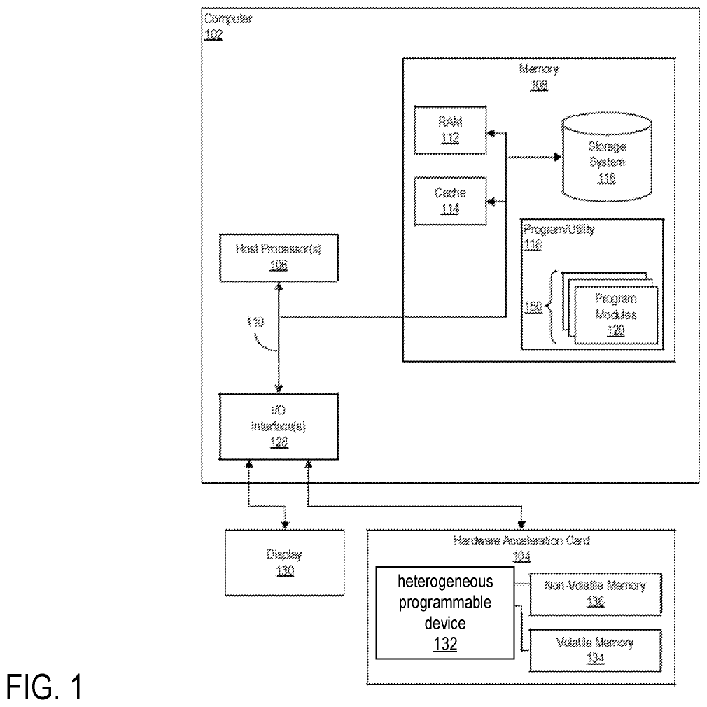

FIG. 1 illustrates an exemplary system that can compress a sparse matrix and compile an application to configure vector processors to multiply the compressed sparse matrix by a vector. The exemplary system includes a computer 102 (sometimes referred to herein as a “host” or “host system”) for use with the inventive arrangements described within this disclosure. Computer 102 may include, but is not limited to, one or more processors 106 (e.g., central processing units), a memory 108, and a bus 110 that couples various system components including memory 108 to processor(s) 106. Processor(s) 106 may include any of a variety of processors that are capable of executing program code. Example processor types include, but are not limited to, processors having an x86 type of architecture (IA-32, IA-64, etc.), Power Architecture, ARM processors, and the like.

Bus 110 represents one or more of any of several types of communication bus structures. Example bus structures include a memory bus, a peripheral bus, a graphics bus, and a processor or local bus. The bus structure may be implemented using any of a variety of available bus architectures. By way of example, and not limitation, such bus architectures include Peripheral Component Interconnect (PCI) bus, PCI Express (PCIe) bus, Advanced Microcontroller Bus Architecture (AMBA) Advanced Extensible Interface (AXI) bus, and/or other known buses.

Computer 102 typically includes a variety of computer readable media. Such media may be any available media that is accessible by computer 102 and may include any combination of volatile media, non-volatile media, removable media, and/or non-removable media.

Memory 108 may include computer readable media in the form of volatile memory, such as random-access memory (RAM) 112 and/or cache memory 114. Computer 102 may also include other removable/non-removable, volatile/non-volatile computer system storage media. By way of example, storage system 116 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each may be connected to bus 110 by one or more data media interfaces. As will be further depicted and described below, memory 108 may include one or more computer program products having a set (e.g., at least one) of program modules (e.g., program code) that are configured to carry out the functions and/or operations described in this disclosure.

For example, program/utility 118, having a set (at least one) of program modules 120 which may include, but are not limited to, an operating system, one or more application programs (e.g., user applications), other program modules, and/or program data, is stored in memory 108. Program modules 120 generally carry out the functions and/or methodologies requiring multiplication of sparse matrices by dense vectors.

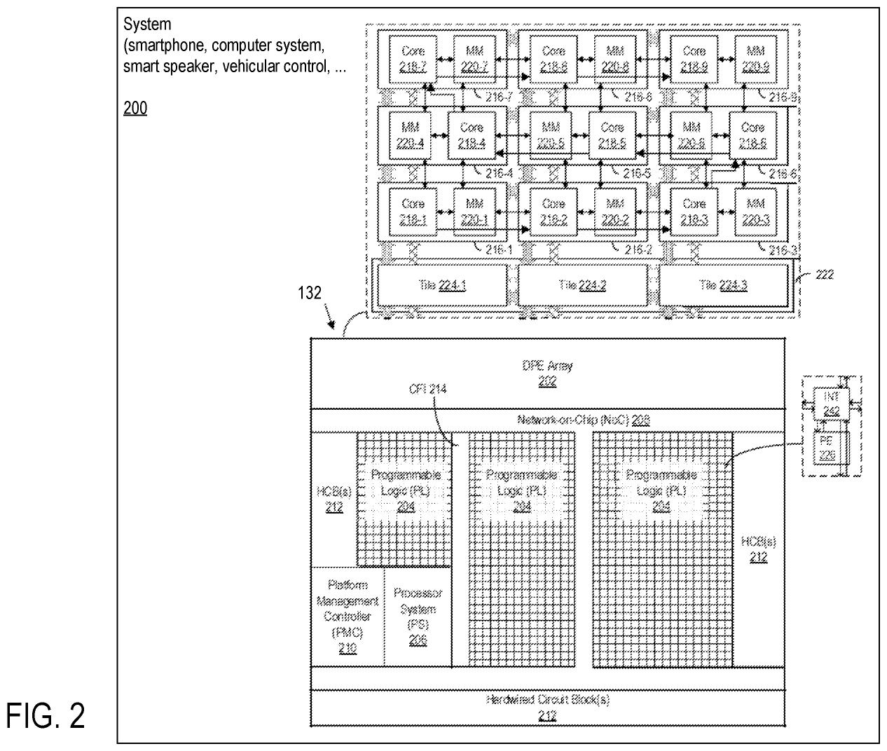

In preparing for applications involving multiplication of sparse matrices by dense vectors, the program modules can implement functions that compress the sparse matrices according to the approaches disclosed herein. Accordingly, the host computer system 102 executing the program modules is an exemplary implementation of a compression processor. In alternative implementations, the compression processor can be implemented by suitably configured programmable logic circuitry. The computer system 102 can also generate a schedule of multiply-and-accumulate (MAC) operations to be performed parallel by and array of data processing engines, which include vectors processors, (FIG. 2) in the heterogeneous programmable device 132.

Program modules 120 may also implement a software stack. The software stack, when executed by computer 102, may implement a runtime environment capable of communicating with hardware acceleration card 104 at runtime. For example, program modules 120 may include a driver or daemon capable of communicating with heterogeneous device 132. Thus, computer 102 may operate as a host that is capable of executing a runtime software system capable of connecting to hardware acceleration card 104.

In another example implementation, computer 102 is used for purposes of developing, e.g., compiling, the user application. Heterogeneous device 132 may include one or more processors therein providing a complete embedded system. In that case, the one or more processors of heterogeneous device 132 may execute the runtime software system such that the one or more processors embedded in heterogeneous device 132 operate as the host system or host processor as the case may be.

Program/utility 118 is executable by processor(s) 106. Program/utility 118 and any data items used, generated, and/or operated upon by processor(s) 106 are functional data structures that impart functionality when employed by processor(s) 106. As defined within this disclosure, a “data structure” is a physical implementation of a data model's organization of data within a physical memory. As such, a data structure is formed of specific electrical or magnetic structural elements in a memory. A data structure imposes physical organization on the data stored in the memory as used by an application program executed using a processor.

Computer 102 may include one or more Input/Output (I/O) interfaces 128 communicatively linked to bus 110. I/O interface(s) 128 allow computer 102 to communicate with external devices, couple to external devices that allow user(s) to interact with computer 102, couple to external devices that allow computer 102 to communicate with other computing devices, and the like. For example, computer 102 may be communicatively linked to a display 130 and to hardware acceleration card 104 through I/O interface(s) 128. Computer 102 may be coupled to other external devices such as a keyboard (not shown) via I/O interface(s) 128. Examples of I/O interfaces 128 may include, but are not limited to, network cards, modems, network adapters, hardware controllers, etc.

In an example implementation, the I/O interface 128 through which computer 102 communicates with hardware acceleration card 104 is a PCIe adapter. Hardware acceleration card 104 may be implemented as a circuit board that couples to computer 102. Hardware acceleration card 104 may, for example, be inserted into a card slot, e.g., an available bus and/or PCIe slot, of computer 102.

Hardware acceleration card 104 includes heterogeneous device 132. Hardware acceleration card 104 also includes volatile memory 134 coupled to heterogeneous device 132 and a non-volatile memory 136 also coupled to heterogeneous device 132. Volatile memory 134 may be implemented as a RAM that is external to heterogeneous device 132, but is still considered a “local memory” of heterogeneous device 132, whereas memory 108, being within computer 102, is not considered local to heterogeneous device 132. In some implementations, volatile memory 134 may include multiple gigabytes of RAM. Non-volatile memory 136 may be implemented as flash memory. Non-volatile memory 136 is also external to heterogeneous device 132 and may be considered local to heterogeneous device 132.

Notably, volatile memory 134 and non-volatile memory 134 are “off-chip memory” relative to memory resources available on the heterogeneous device 132. That is, heterogeneous device 132 can have RAM banks disposed on the same IC die or package as programmable logic and routing resources of the device, and access to the volatile memory 134 and non-volatile memory 136 is provided to logic on the device way of a memory bus protocol, such as AXI DMA or AXI stream.

FIG. 1 is not intended to suggest any limitation as to the scope of use or functionality of the examples described herein. Computer 102 is an example of computer hardware (e.g., a system) that is capable of performing the various operations described within this disclosure relating to implementing user applications and/or runtime interactions with hardware acceleration card 104 and/or heterogeneous device 132. Heterogeneous device 132, for example, may be implemented as a programmable IC.

Computer 102 is only one example implementation of a computer that may be used with a hardware acceleration card. Computer 102 is shown in the form of a computing device, e.g., a computer or server. Computer 102 can be practiced as a standalone device, as a bare metal server, in a cluster, or in a distributed cloud computing environment. In a distributed cloud computing environment, tasks are performed by remote processing devices that are linked through a communications network. In a distributed cloud computing environment, program modules may be located in both local and remote computer system storage media including memory storage devices.

FIG. 2 illustrates an exemplary system 200 having an array of data processing engines (DPEs) that can be configured to multiply compressed sparse matrix(s) by an input vector(s) for various applications. The system 200 can be an implementation of a smartphone, desktop computer, server application, vehicular control system or any other system. As such, in addition to the heterogeneous device 132, the system can include components (not shown) such as a display screen, speaker, microphone, non-volatile storage, etc.

The heterogeneous device 132 can be implemented as a System-on-Chip (SoC) or System-in-Package (SiP). In one example, heterogeneous device 132 can be implemented on a single IC die provided within a single integrated package. In other examples, heterogeneous device 132 may be implemented using a plurality of interconnected dies where the various programmable circuit resources and/or subsystems illustrated in FIG. 2 are implemented across the different interconnected dies.

In the example, heterogeneous device 132 includes a data processing engine (DPE) array 202, programmable logic (PL) 204, a processor system (PS) 206, a Network-on-Chip (NoC) 208, a platform management controller (PMC) 210, and one or more hardwired circuit blocks (HCBs) 212. A configuration frame interface (CFI) 214 is also included. For purposes of discussion, each of DPE array 202, PL 204, PS 206, NoC 208, PMC 210, and each HCB 212 is an example of a subsystem of heterogeneous device 132.

DPE array 202 is implemented as a plurality of interconnected and programmable data processing engines (DPEs) 216. DPEs 216 may be arranged in an array and are hardwired. Each DPE 216 can include one or more cores 218 and a memory module (abbreviated “MM” in FIG. 2) 220. In one aspect, each core 218 is capable of executing program code stored in a core-specific program memory contained within each respective core (not shown). Each core 218 is capable of directly accessing the memory module 220 within the same DPE 216 and the memory module 220 of any other DPE 216 that is adjacent to the core 218 of the DPE 216 in the up, down, left, and right directions. For example, core 218-5 is capable of directly reading and/or writing (e.g., via respective memory interfaces not shown) memory modules 220-5, 220-8, 220-6, and 220-2. Core 218-5 sees each of memory modules 220-5, 220-8, 220-6, and 220-2 as a unified region of memory (e.g., as a part of the local memory accessible to core 218-5). This facilitates data sharing among different DPEs 216 in DPE array 202. In other examples, core 218-5 may be directly connected to memory modules 220 in other DPEs.

Though optimized for dense arithmetic operations, the DPEs can be configured to perform some processing of sparse matrices. Sparse matrix computation can be efficiently implemented on the DPEs by generating code specialized for a given sparse matrix. In many inference use cases sparse weights are fixed at design time, and specifically programmed DPEs can benefit those use cases. Programming DPEs for inference use cases involves dividing the weights of each layer into several partitions and mapping the computations associated with each partition to a DPE. After partitioning, program code is generated for the DPEs and configuring the vector permute network (not shown) to select the correct data for each operation. Partitioning the weights across multiple DPEs can enable the weights in some applications to be stored entirely on-chip, thereby avoiding the need to load weights from external memory during runtime.

DPEs 216 are interconnected by programmable DPE interconnect circuitry. The programmable DPE interconnect circuitry may include one or more different and independent networks. For example, the programmable DPE interconnect circuitry may include a streaming network formed of streaming connections (shaded arrows), a memory mapped network formed of memory mapped connections (cross-hatched arrows).

Loading configuration data into control registers of DPEs 216 by way of the memory mapped connections allows each DPE 216 and the components therein to be controlled independently. DPEs 216 may be enabled/disabled on a per-DPE basis. Each core 218, for example, may be configured to access the memory modules 220 as described or only a subset thereof to achieve isolation of a core 218 or a plurality of cores 218 operating as a cluster. Each streaming connection may be configured to establish logical connections between only selected ones of DPEs 216 to achieve isolation of a DPE 216 or a plurality of DPEs 216 operating as a cluster. Because each core 218 may be loaded with program code specific to that core 218, each DPE 216 is capable of implementing one or more different kernels therein.

Cores 218 may be directly connected with adjacent cores 218 via core-to-core cascade connections. In one aspect, core-to-core cascade connections are unidirectional and direct connections between cores 218 as pictured. In another aspect, core-to-core cascade connections are bidirectional and direct connections between cores 218. In general, core-to-core cascade connections generally allow the results stored in an accumulation register of a source core to be provided directly to an input of a target or load core. Activation of core-to-core cascade interfaces may also be controlled by loading configuration data into control registers of the respective DPEs 216.

SoC interface block 222 operates as an interface that connects DPEs 216 to other resources of heterogeneous device 132. In the example of FIG. 2, SoC interface block 222 includes a plurality of interconnected tiles 224 organized in a row. In particular embodiments, different heterogeneous devices 132 may be used to implement tiles 224 within SoC interface block 222 where each different tile architecture supports communication with different resources of heterogeneous device 132. Tiles 224 are connected so that data may be propagated from one tile to another bi-directionally. Each tile 224 is capable of operating as an interface for the column of DPEs 216 directly above.

Tiles 224 are connected to adjacent tiles, to DPEs 216 immediately above, and to circuitry below using the streaming connections and the memory mapped connections as shown. Tiles 224 may also include a debug network that connects to the debug network implemented in DPE array 202. Each tile 224 is capable of receiving data from another source such as PS 206, PL 204, and/or another HCB 212. Tile 224-1, for example, is capable of providing those portions of the data, whether application or configuration, addressed to DPEs 216 in the column above to such DPEs 216 while sending data addressed to DPEs 216 in other columns on to other tiles 224, e.g., 224-2 or 224-3, so that such tiles 224 may route the data addressed to DPEs 216 in their respective columns accordingly.

In one aspect, SoC interface block 222 includes two different types of tiles 224. A first type of tile 224 has an architecture configured to serve as an interface only between DPEs 216 and PL 204. A second type of tile 224 is has an architecture configured to serve as an interface between DPEs 216 and NoC 208 and also between DPEs 216 and PL 204. SoC interface block 222 may include a combination of tiles of the first and second types or tiles of only the second type.

PL 204 is circuitry that can be programmed to perform specified functions. As an example, PL 204 may be implemented as field programmable gate array (FPGA) type of circuitry. PL 204 can include an array of programmable circuit blocks. As defined herein, the term “programmable logic” means circuitry used to build reconfigurable digital circuits. Programmable logic is formed of many programmable circuit blocks sometimes referred to as “tiles” that provide basic functionality. The topology of PL 204 is highly configurable unlike hardwired circuitry. Each programmable circuit block of PL 204 typically includes a programmable element 226 (e.g., a functional element) and a programmable interconnect 242. The programmable interconnects 242 provide the highly configurable topology of PL 204. The programmable interconnects 242 may be configured on a per wire basis to provide connectivity among the programmable elements 226 of programmable circuit blocks of PL 204 and is configurable on a per-bit basis (e.g., where each wire conveys a single bit of information) unlike connectivity among DPEs 216, for example.

Examples of programmable circuit blocks of PL 204 include configurable logic blocks having look-up tables and registers. Unlike hardwired circuitry described below and sometimes referred to as hard blocks, these programmable circuit blocks have an undefined function at the time of manufacture. PL 204 may include other types of programmable circuit blocks that also provide basic and defined functionality with more limited programmability. Examples of these circuit blocks may include digital signal processing blocks (DSPs), phase lock loops (PLLs), and block random access memories (BRAMs). These types of programmable circuit blocks, like others in PL 204, are numerous and intermingled with the other programmable circuit blocks of PL 204. These circuit blocks may also have an architecture that generally includes a programmable interconnect 242 and a programmable element 226 and, as such, are part of the highly configurable topology of PL 204.

Prior to use, PL 204, e.g., the programmable interconnect and the programmable elements, must be programmed or “configured” by loading data referred to as a configuration bitstream into internal configuration memory cells therein. The configuration memory cells, once loaded with a configuration bitstream, define how PL 204 is configured, e.g., the topology, and operates (e.g., particular functions performed). Within this disclosure, a “configuration bitstream” is not equivalent to program code executable by a processor or computer.

PS 206 is implemented as hardwired circuitry that is fabricated as part of heterogeneous device 132. PS 206 may be implemented as, or include, any of a variety of different processor types each capable of executing program code. For example, PS 206 may be implemented as an individual processor, e.g., a single core capable of executing program code. In another example, PS 206 may be implemented as a multi-core processor. In still another example, PS 206 may include one or more cores, modules, co-processors, I/O interfaces, and/or other resources. PS 206 may be implemented using any of a variety of different types of architectures. Example architectures that may be used to implement PS 206 may include, but are not limited to, an ARM processor architecture, an x86 processor architecture, a graphics processing unit (GPU) architecture, a mobile processor architecture, a DSP architecture, combinations of the foregoing architectures, or other suitable architecture that is capable of executing computer-readable instructions or program code. In one aspect, PS 206 may include one or more application processors and one or more real-time processors.

NoC 208 is a programmable interconnecting network for sharing data between endpoint circuits in heterogeneous device 132. The endpoint circuits can be disposed in DPE array 202, PL 204, PS 206, and/or selected HCBs 212. NoC 208 can include high-speed data paths with dedicated switching. In an example, NoC 208 includes one or more horizontal paths, one or more vertical paths, or both horizontal and vertical path(s). The arrangement and number of regions shown in FIG. 2 is merely an example. NoC 208 is an example of the common infrastructure that is available within heterogeneous device 132 to connect selected components and/or subsystems.

Within NoC 208, the nets that are to be routed through NoC 208 are unknown until a user application is created for implementation within heterogeneous device 132. NoC 208 may be programmed by loading configuration data into internal configuration registers that define how elements within NoC 208 such as switches and interfaces are configured and operate to pass data from switch to switch and among the NoC interfaces to connect the endpoint circuits. NoC 208 is fabricated as part of heterogeneous device 132 (e.g., is hardwired) and, while not physically modifiable, may be programmed to establish connectivity between different master circuits and different slave circuits of a user application. NoC 208, upon power-on, does not implement any data paths or routes therein. Once configured, e.g., by PMC 210, however, NoC 208 implements data paths or routes between endpoint circuits.

PMC 210 is responsible for managing heterogeneous device 132. PMC 210 is a subsystem within heterogeneous device 132 that is capable of managing the programmable circuit resources across the entirety of heterogeneous device 132. PMC 210 is capable of maintaining a safe and secure environment, booting heterogeneous device 132, and managing heterogeneous device 132 during operation. For example, PMC 210 is capable of providing unified and programmable control over power-up, boot/configuration, security, power management, safety monitoring, debugging, and/or error handling for the different programmable circuit resources of heterogeneous device 132 (e.g., DPE array 202, PL 204, PS 206, and NoC 208). PMC 210 operates as a dedicated platform manager that decouples PS 206 and from PL 204. As such, PS 206 and PL 204 may be managed, configured, and/or powered on and/or off independently of one another.

PMC 210 may be implemented as a processor with dedicated resources. PMC 210 may include multiple redundant processors. The processors of PMC 210 are capable of executing firmware. Use of firmware (e.g., executable program code) supports configurability and segmentation of global features of heterogeneous device 132 such as reset, clocking, and protection to provide flexibility in creating separate processing domains (which are distinct from “power domains” that may be subsystem-specific). Processing domains may involve a mixture or combination of one or more different programmable circuit resources of heterogeneous device 132 (e.g., wherein the processing domains may include different combinations or devices from DPE array 202, PS 206, PL 204, NoC 208, and/or other HCB(s) 212).

HCBs 212 include special-purpose circuit blocks fabricated as part of heterogeneous device 132. Though hardwired, HCBs 212 may be configured by loading configuration data into control registers to implement one or more different modes of operation. Examples of HCBs 212 may include input/output (I/O) blocks, transceivers for sending and receiving signals to circuits and/or systems external to heterogeneous device 132, memory controllers, or the like. Examples of different I/O blocks may include single-ended and pseudo differential I/Os. Examples of transceivers may include high-speed differentially clocked transceivers. Other examples of HCBs 212 include, but are not limited to, cryptographic engines, digital-to-analog converters (DACs), analog-to-digital converters (ADCs), and the like. In general, HCBs 212 are application-specific circuit blocks.

CFI 214 is an interface through which configuration data, e.g., a configuration bitstream, may be provided to PL 204 to implement different user-specified circuits and/or circuitry therein. CFI 214 is coupled to and accessible by PMC 210 to provide configuration data to PL 204. In some cases, PMC 210 is capable of first configuring PS 206 such that PS 206, once configured by PMC 210, may provide configuration data to PL 204 via CFI 214. In one aspect, CFI 214 has a built in cyclic redundancy checking (CRC) circuitry (e.g., CRC 32-bit circuitry) incorporated therein. As such, any data that is loaded into CFI 214 and/or read back via CFI 214 may be checked for integrity by checking the values of codes attached to the data.

The various programmable circuit resources illustrated in FIG. 2 can be programmed initially as part of a boot process for heterogeneous device 132. During runtime, the programmable circuit resources may be reconfigured. In one aspect, PMC 210 is capable of initially configuring DPE array 202, PL 204, PS 206, and NoC 208. At any point during runtime, PMC 210 may reconfigure all or a portion of heterogeneous device 132. In some cases, PS 206 may configure and/or reconfigure PL 204 and/or NoC 208 once initially configured by PMC 210.

In another aspect, a heterogeneous device includes dedicated on-chip circuitry that exposes I/O interfaces (e.g., AXI bus interfaces or other communication bus interfaces) to other portions of the heterogeneous device. For example, referring to the example of FIG. 2, heterogeneous device 132 may include dedicated on-chip circuitry that exposes AXI interfaces to DPE array 202, PL 204, NoC 208, DSP blocks in PL 204, HCBs 212, and/or other programmable I/O included in heterogeneous device 132

FIG. 2 is provided as an example of a heterogeneous device. In other examples, particular subsystems such as PS 206 may be omitted. For example, a heterogeneous device may include DPE array 202 in combination with PL 204. In another example, a heterogeneous device may include DPE array 202 in combination with NoC 208 and PL 204. One or more HCB(s) also may be included in the alternative examples described.

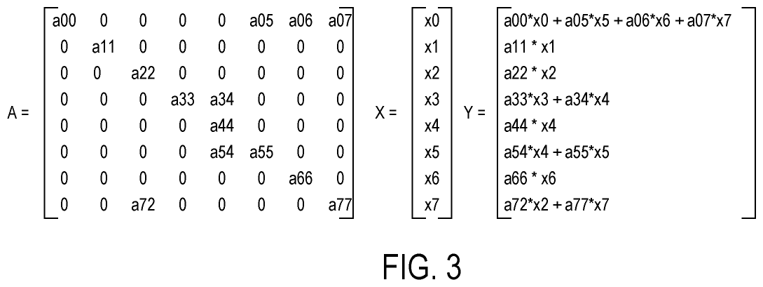

FIG. 3 shows an example of a sparse matrix A, a dense vector X, and a vector Y that is the result of multiplying the sparse matrix by the dense vector. The example is presented to aid in describing the disclosed circuits and methods. The non-zero data elements of the sparse matrix are denoted aJK, where J is the row index and K is the column index of the data element. Each element in the result vector Y is a dot product of one of the rows of A and the vector data elements x0, . . . , x7.

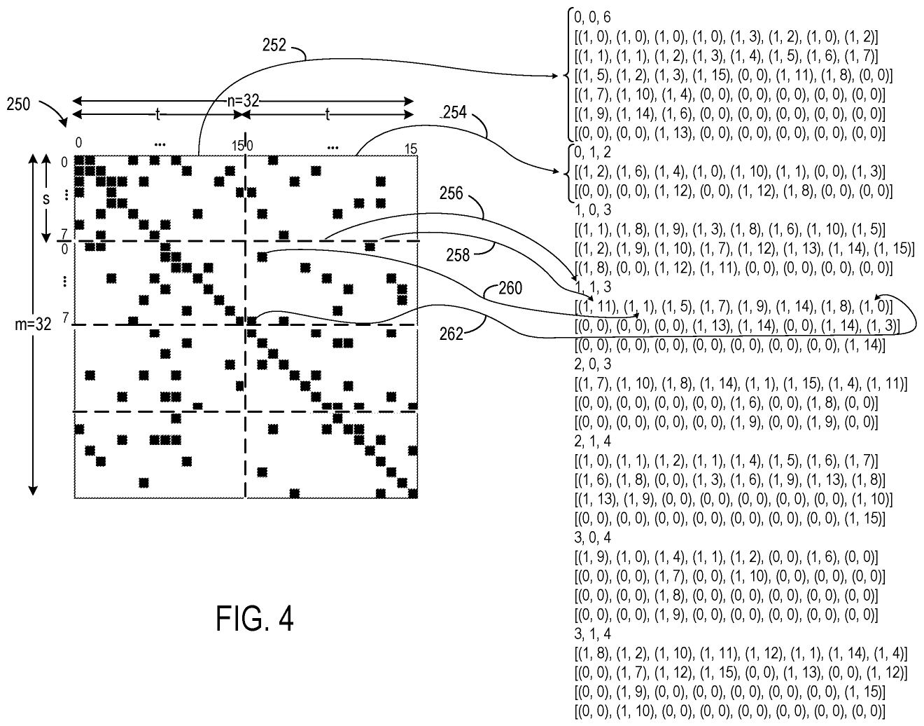

FIG. 4 shows an example of a sparse matrix 250 compressed into groups of ordered sets of tuples. Each black square in the matrix indicates an element having a non-zero value (alternatively “non-zero element”). For ease of illustration, the non-zero values are all equal to 1.

The exemplary sparse matrix has 32 rows (m=32) and 32 columns (n=32). The matrix is divided into 8 partitions with each partition having 8 rows (s=8) and 16 columns (t=16). Those skilled in the art will recognize that the matrix size is exemplary, and applications are likely to have much larger sparse matrices. However, the size of the partitions can be tailored to the architecture of the target device. For example, the number of rows in a partition can be the same as or a multiple of the number of parallel MAC operations that can be performed by a vector processor. The number of columns in a partition can be selected to reduce storage requirements. For example, hexadecimal encoding can be used to reference column indices for a 16-column partition, and the column indices associated with 8 rows of a partition can be packed into one 32-bit integer.

Each partition having one or more non-zero elements will reduce to a group having at least one ordered set of tuples, and the number of ordered sets can vary according to the number and distribution of non-zero elements in the partitions. The number of tuples in each ordered set corresponds to the number of rows in a partition. In the example, each partition has 8 rows and each ordered set has 8 tuples.

Curved line 252 shows the mapping of the partition at partition row 0, partition column 0 (“partition 0,0”) to a group of ordered sets of tuples. Partition 0,0 has 6 ordered sets of tuples. Curved line 254 shows the mapping of partition 0,1 to a group of 2 ordered sets of tuples.

The partition row and partition column and the number of ordered sets in each group are associated with the group. For example, curved line 256 shows the mapping of partition 1,1 to the values 1, 1, 3.

Each tuple includes the non-zero value and the column index of the partition at which the associated non-zero value is located. Curved lines 258, 260, and 262 show the mapping of three of the non-zero elements of partition 1,1, to tuples (1,11), (1,1), and 1,0), respectively. A tuple having a zero value paired with a zero column index indicates that there are no non-zero values that have not already been paired in the row.

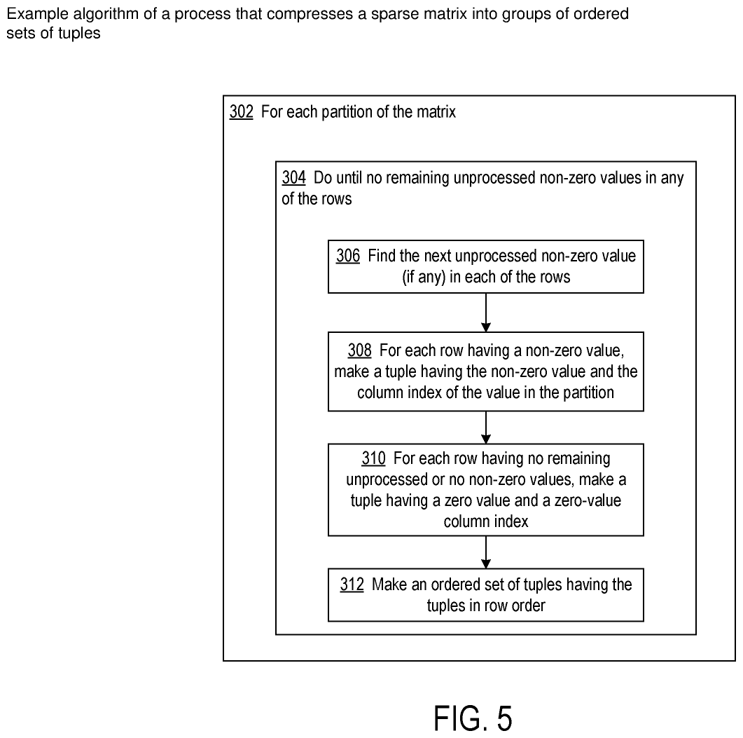

FIG. 5 shows a flowchart of an exemplary algorithm for compressing a sparse matrix into groups of ordered sets of tuples. For each partition of the matrix, a compression processor performs the processing of block 302, and the processing of block 304 is repeated until there are no remaining unprocessed non-zero values in any of the rows of the partition.

At block 306, the compression processor finds the next unprocessed non-zero element (if any) in each of the rows of the partition. For each row in which an unprocessed non-zero element is found, at block 308 the compression processor makes a tuple having the value of the non-zero element and the column index of that element in the partition. For each row having no remaining unprocessed non-zero elements or having no non-zero elements at all, at block 310 the compression processor makes a tuple having the value 0 and an arbitrary column index, such as 0. At block 312, the compression processor makes an ordered set of tuples from the tuples generated at blocks 308 and 310. The positions of the tuples in the ordered set correspond to the partition rows of the non-zero values in the tuples. For example, the tuple generated for the first row of the partition will occupy the first position in the ordered set, the tuple generated for the second row of the partition will occupy the second position in the ordered set, the tuple generated for the third row of the partition will occupy the third position in the ordered set and so on.

According to an exemplary implementation, in making the tuples the compression processor can store the ordered sets of tuples as vectors in memory circuitry for efficient storage and processing in multiplying the compressed matrix by an input vector.

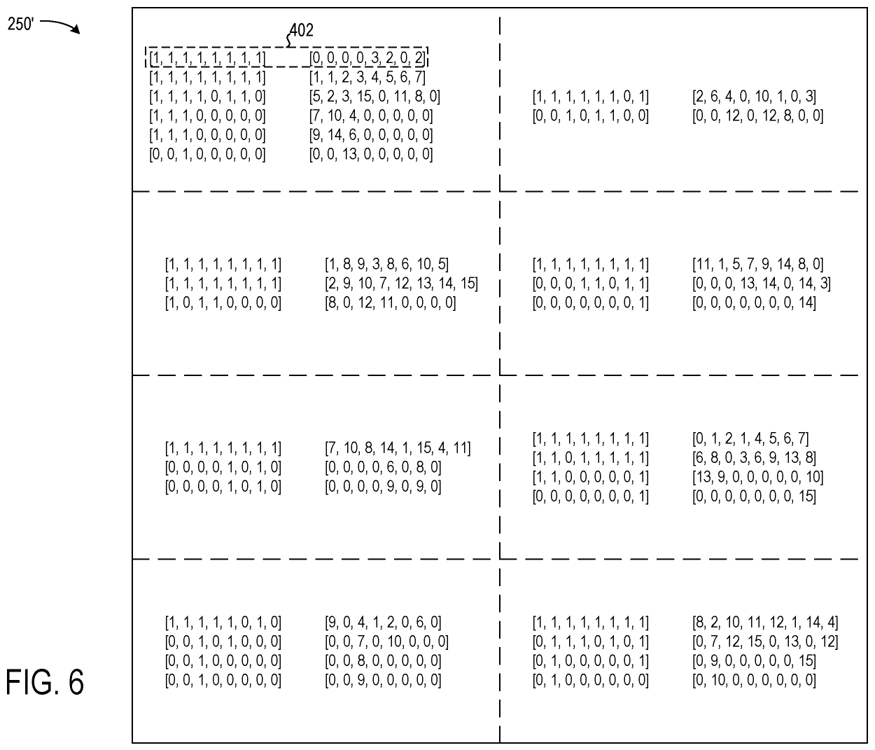

FIG. 6 shows the vectors associated with the example of FIG. 4. The partitions of the compressed matrix 250′ are delineated by dashed lines, and the vectors associated with each partition are listed within the partition.

Each ordered set of tuples (FIG. 4) is stored as a “value vector” and an associated “column-index vector.” The elements of the value vector are the non-zero and zero values of elements in the partition, and the elements of the column-index vector are the associated column indices from the tuples. For example, in FIG. 4 the ordered set of tuples, [(1, 0), (1, 0), (1, 0), (1, 0), (1, 3), (1, 2), (1, 0), (1, 2)], can be stored as a value vector [1, 1, 1, 1, 1, 1, 1, 1] and column-index vector [0, 0, 0, 0, 3, 2, 0, 2] (as highlighted by dashed block 402).

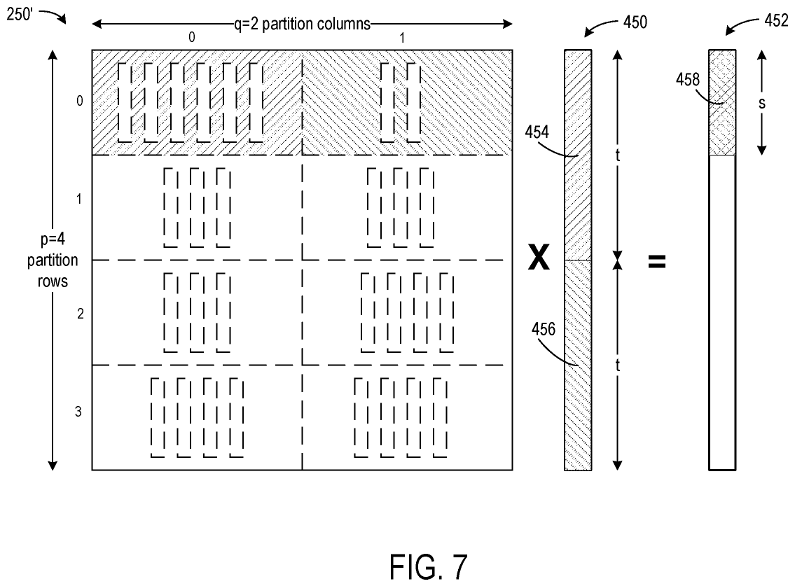

FIG. 7 shows the partial multiplication of compressed sparse matrix 250′ by an input vector. The result of the partial multiplication is shown as block 452. The intent of showing the partial multiplication is to illustrate the MAC operations performed on the compressed data of two of the partitions and two corresponding portions of the input vector to produce part of the output vector. The compressed matrix 250′ corresponds to the example of FIGS. 4 and 6.

The dashed blocks within each partition represent the ordered sets of tuples (or pairs of value vectors and column-index vectors) in that partition. For example, partition 0,0 has 6 ordered sets of tuples/pairs of vectors, and partition 0,1 has two ordered sets of tuples/pairs of vectors.

The compressed data of partition 0,0 is multiplied by elements selected from the portion 454 of the input vector 450 and accumulated by row, and the compressed data of partition 0,1 is multiplied by elements selected from the portion 456 of the input vector 450 and accumulated by row with the accumulated products from partition 0,0 and portion 456. The accumulations of the products of the rows from partitions 0,0, and 1,1 are elements 458 of the output vector 452.

Notably, the MAC operations associated with partition 0,0 and the MAC operations associated with partition 1,1 can be mapped to separate vector processors and performed in parallel.

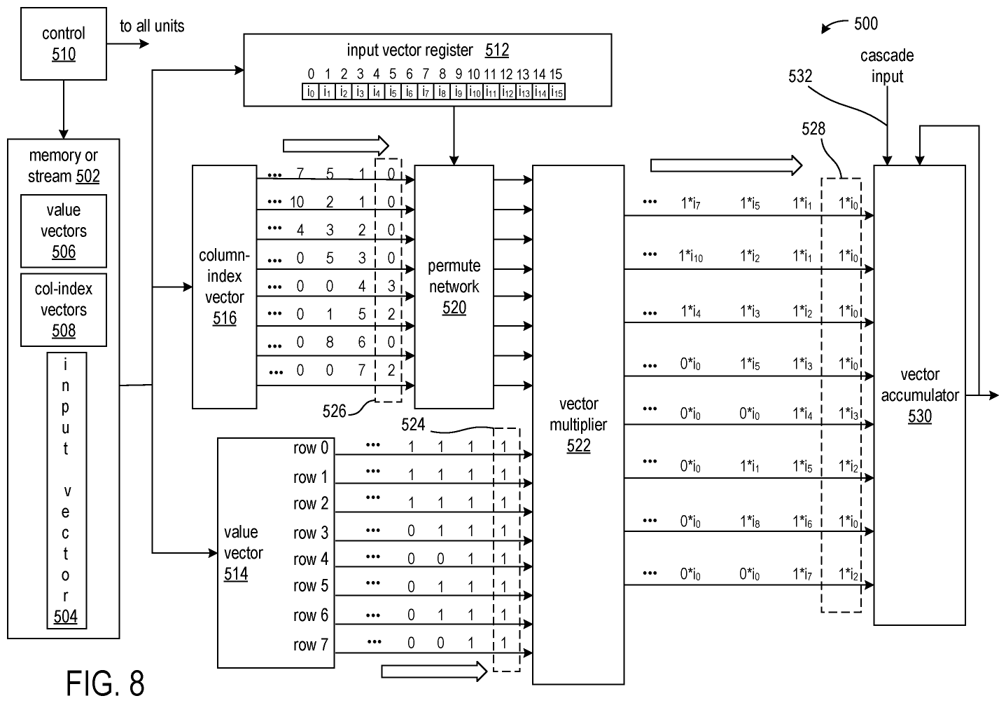

FIG. 8 shows an exemplary vector processor 500 and an input sequence of value vectors and column-index vectors. The sequence of value vectors and column-index vectors are from the example of FIGS. 4 and 6. The input sequence and the resulting products illustrate the programmed operations of the vector processor in performing MAC operations involved in multiplying a compressed partition of a sparse matrix by a portion of an input vector.

The vector processor 500 can include a memory 502 or be coupled to streaming interface to input a portion of the input vector 504 and the value vectors 506 and column-index vectors 508 that represent a partition of a compressed sparse matrix. The control circuit 510 can enable storage of a portion of the input vector in register circuitry 512, enable storage of a value vector in register circuitry 514, and enable storage of the associated column-index vector in register 516.

The register circuitry 512 can include registers for storing t elements of the input vector, where t is the number of columns in each partition of the sparse matrix. In an exemplary implementation, t=16. In an implementation in which t=16, each column-index vector can be represented by one 32-bit integer, and each index value can be a hexadecimal value. The column-index vector register 516 can be a 32-bit register in such an implementation.

The register circuitry 514 can store the s values in an input value vector, where s is the number of rows in each partition of the sparse matrix. In an exemplary implementation, s=8, and each value is 32 bits.

The permute network 518 selects s elements of the portion of the input vector present in register circuitry 512 for input to the vector multiplier 522. The permute network has s selection inputs from the column-index register 516 and t data inputs from the register circuitry 512. The permute network selects s elements from the registers for input to the vector multiplier, and each selection is in response to an element of the column-index vector. For each of the s elements of the input column index vector, the permute network selects one of the t elements from the portion of the input vector. According to one example, the permute network can be implemented as s multiplexers having t data inputs.

The sequences of numbers above the output lines from the registers 514 and 516 correspond to the first four pairs of value vectors and associated column-index vectors of partition 0,0 from the example of FIGS. 4 and 6. Dashed block 524 shows the values of the first value vector, and dashed block 526 shows the values the associated column-index vector (see FIG. 4, #402).

The elements of the column index vector cause the permute network 520 to select input vector elements i₀, i₀, i₀, i₀, i₃, i₂, i₀, i₂, from the register circuitry 512 and output the values to the vector multiplier 522. The vector multiplier performs s multiplications in parallel. Block 528 shows the s products generated by the vector multiplier from the s values of the value vector 524 and the values of the selected elements of the input vector, as referenced by the column indices in the column index vector 526.

The vector accumulator 530 accumulates s respective sums in parallel from the s sequences of products generated by the vector multiplier 522 and from cascade input 532. The cascade input can include s sums accumulated by another vector processor that is configured to generate partial results from the value vectors and column-index vectors of another partition covering the same rows of the sparse matrix.

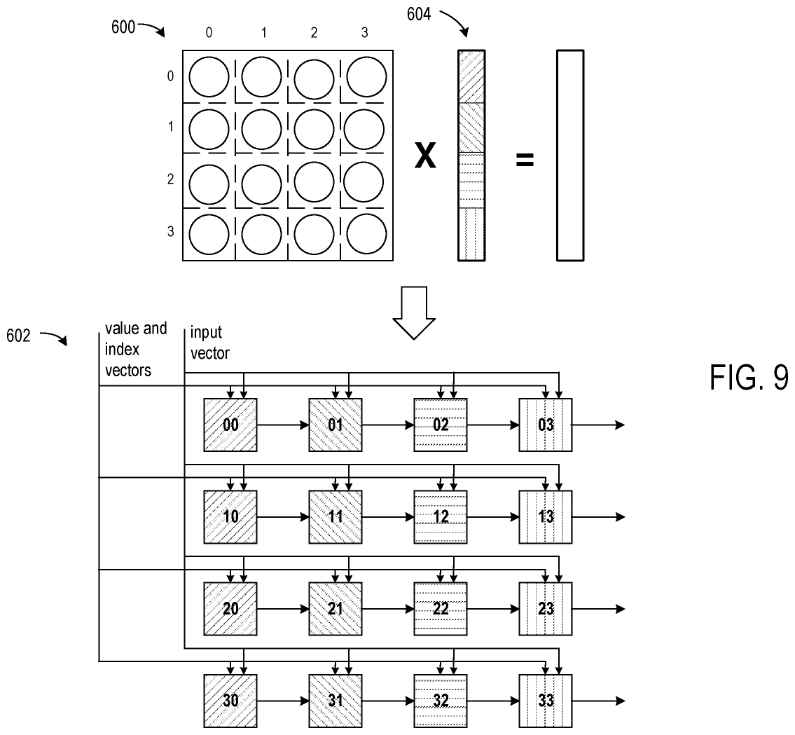

FIG. 9 shows an exemplary mapping of partitions of a sparse matrix to an array of vector processors. Sparse matrix 600 is divided into 16 partitions, and the circles in the partitions represent the mappings of the MAC operations associated with the partitions to vector processors. The exemplary mapping maps the processing to an array 602 of 16 vector processors.

The input vector 604 is divided into 4 portions, which are represented by the different hash lines. Each of the processors is shown with hash lines that correspond to the portion of the input vector input to the processor for multiplication.

In the example, the operations associated with a row of partitions are mapped to processors in a row of the array 602. For example, operations associated with partition 0,0, are mapped to processor 00, operations associated with partition 0,1 are mapped to processor 01, operations associated with partition 0,2 are mapped to processor 02, and operations associated with partition 0,3 are mapped to processor 03.

FIG. 9 shows one exemplary mapping, though other mappings are possible and may be beneficial based on the level of sparsity and distribution of non-zero elements.

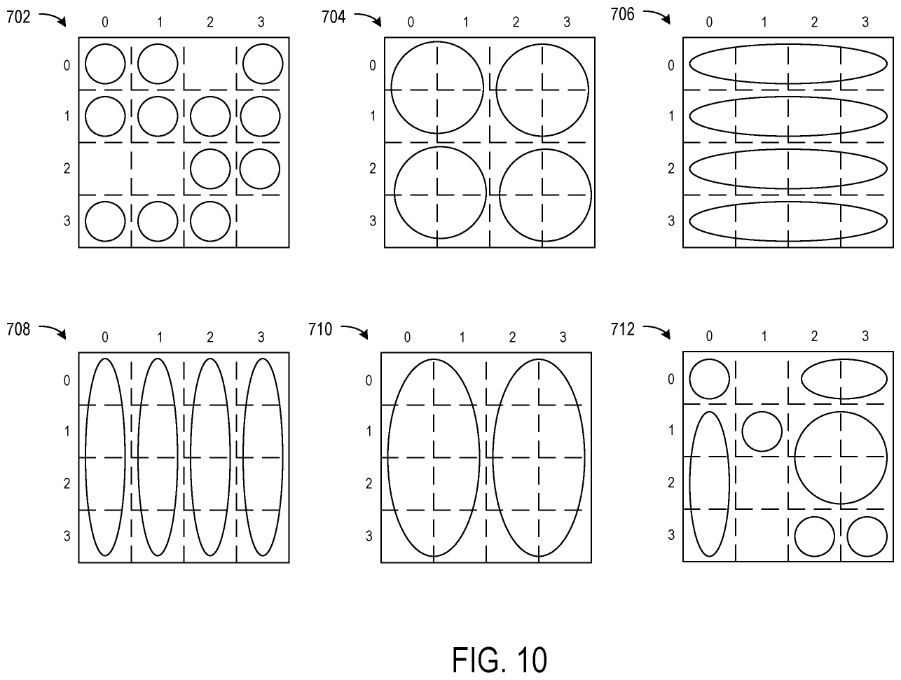

FIG. 10 shows examples of different mappings of the MAC processing associated with a sparse matrix having 16 partitions. Each circle or and ellipse represents a mapping of MAC operations to a vector processor. The different mappings may be made in response to the distribution of the non-zero elements in the matrix. Partitions that are not partially encompassed by a circle or ellipse have no value vectors and column-index vectors for mapping.

Matrix 702 shows a mapping in which some of the partitions, for example, partition 0,2, have no vectors mapped for processing. The mapping of matrix 702 shows that each vector processor of multiple vector processors is configured to generate s products and s respective partial sums from one and only one partition of the partitions.

Matrix 704 shows a mapping in which the vectors in multiple partitions are mapped to one vector processor. For example, the vectors of partitions 0,0, 0,1, 1,0 and 1,1 are mapped to the same vector processor.

Matrix 706 shows a mapping in which the vectors of all the partitions in a row of partitions are mapped to the same vector processor. For example, the vectors of partitions 0,0, 0,1, 0,2, and 0,3 are mapped to the same vector processor.

Matrix 708 shows a mapping in which the vectors of all the partitions in a column of partitions, which cover different subsets of rows, are mapped to the same vector processor. For example, the vectors of partitions 0,0, 1,0, 2,0, and 3,0 are mapped to the same vector processor. Though the example of matrix 704 shows a mapping of four partitions (2 partition rows×2 partition columns) to a vector processor, a different sparse matrix could have a mapping in which three partitions of two columns and two rows are mapped to a vector processor. For example, instead of a mapping covering partitions 0,0, 0,1, 1,0, and 1,1, an alternative mapping could cover partitions 0,0, 0,1, and 1,1 but not partition 1,0.

Matrix 710 shows a mapping in which the vectors of all the partitions in all the rows in multiple columns are mapped to the same vector processor. For example, the vectors of partitions 0,0, 1,0, 2,0, 3,0 0,1, 1,1, 2,1, and 3,1 are mapped to the same vector processor. Matrix 712 shows a mapping having a combination of mappings.

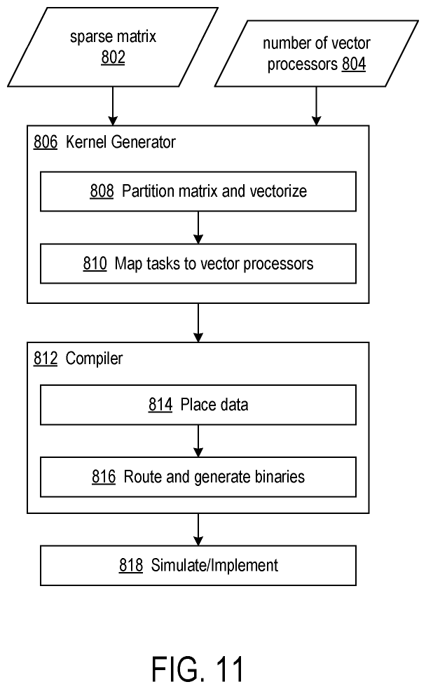

FIG. 11 shows a flowchart of exemplary processes of generating programming data to simulate or configure a target device to multiply a sparse matrix by an input vector. The processes can be implemented by one or more software programs executing on a computer system as a “design tool.” The design tool inputs a sparse matrix 802 and data 804 that indicates the number of vector processors to which the processing is to be mapped, along with the number of MAC operations that can be performed in parallel by each vector processor.

At block 806, a kernel generator process partitions the matrix and generates value vectors and associated column-index vectors for each partition, as shown by block 808. And at block 810, the kernel generator process maps the MAC tasks associated with the vectors to the vector processors.

The partitioning, vectorizing, and mapping is generally performed in three stages. The first stage divides an input matrix into partitions of 8 rows×16 column, and the matrix elements in each partition are arranged as pairs of vectors of element values and associated column indices. The second stage determines how the matrix should be processed by dividing the matrix into groups of rows that are to be processed together and assigning processing of partitions within those rows to specific vector processors. In the third stage, the compression processor generates the code files according to the mapping, including the graph file, headers, and kernels (with their respective data and indexes).

At block 812, a compiler generates data that configures a target device and programs the vector processors to multiply the sparse matrix 802 by an input vector. At block 814, the compiler generates code for placing the vectors in memories local to the vector processors. At block 816, the compiler generates binary code that is executable by the vector processors to perform the MAC operations. The compiler also generates configuration data for routing connections between the vector processors in order to accumulate results from the vector processors according to the mapping.

At block 818, the output from the design tool can be used to simulate a target device or configure a target device to multiply the sparse matrix by the input vector.

Various logic may be implemented as circuitry to carry out one or more of the operations and activities described herein and/or shown in the figures. In these contexts, a circuit or circuitry may be referred to as “logic,” “module,” “engine,” or “block.” It should be understood that logic, modules, engines and blocks are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Those skilled in the art will appreciate that various alternative computing arrangements, including one or more processors and a memory arrangement configured with program code, would be suitable for hosting the processes and data structures disclosed herein. In addition, the processes may be provided via a variety of computer-readable storage media or delivery channels such as magnetic or optical disks or tapes, electronic storage devices, or as application services over a network.

Though aspects and features may in some cases be described in individual figures, it will be appreciated that features from one figure can be combined with features of another figure even though the combination is not explicitly shown or explicitly described as a combination.

The methods and systems are thought to be applicable to a variety of systems involving circuitry that multiplies sparse matrices by dense vectors. Other aspects and features will be apparent to those skilled in the art from consideration of the specification. It is intended that the specification and drawings be considered as examples only, with a true scope of the invention being indicated by the following claims.

What is claimed is:

1. A method comprising:
determining in each partition of a plurality of partitions of an m×n matrix by a compression processor, row and column indices of elements having non-zero values, wherein each partition has s rows and t columns and s<m and t<n;
generating, by the compression processor, a group of one or more ordered sets of tuples from the elements and row and column indices in each partition of the plurality of partitions that has at least one non-zero element, wherein:
each ordered set includes s tuples, and positions of the s tuples in the ordered set correspond to the s rows of the partition,
each tuple includes a value of an element of the partition and an associated column index, and
the associated column index indicates, for an element of the partition having a non-zero value, a column index in the partition; and
indicating, by the compression processor, for each group of one or more ordered sets of tuples, a count of the one or more ordered sets, a partition row number, and a partition column number.

2. The method of claim 1, wherein the generating the one or more ordered sets of tuples includes:
storing each ordered set of tuples as a value vector having s elements and a corresponding column-index vector having s elements, wherein:
each element in the value vector has the value of the element of the partition from a corresponding tuple of the ordered set of tuples, and an indexed location in the value vector of each value corresponds to a row of the partition, and
the column-index vector has indexed locations that correspond to indexed locations in the value vector, and values of elements in the column-index vector indicate column indices in the partition of values in corresponding indexed locations in the value vector.

3. The method of claim 1, wherein s is equal to a number of multiplication operations that can be performed in parallel by a vector processor.

4. The method of claim 1, wherein t=16, and the generating the one or more ordered sets of tuples includes:
storing each ordered set of tuples as a value vector having s elements and a corresponding column-index vector having s elements, wherein:
each element in the value vector has the value of the element of the partition from a corresponding tuple of the ordered set of tuples, and an indexed location in the value vector of each value corresponds to a row of the partition, and
the column-index vector has indexed locations that correspond to indexed locations in the value vector, and values of elements in the column-index vector are hexadecimal values that indicate column indices in the partition of values in corresponding indexed locations in the value vector.

5. The method of claim 4, wherein s=8 and the storing each ordered set of tuples includes storing each column-index vector as a 32-bit word.

6. A circuit arrangement comprising:
first register circuitry configured to store t elements of an input vector;
a control circuit configured to input:
a sequence of one or more value vectors, each value vector having s elements of a partition of a plurality of partitions of an m×n matrix, wherein the partition has s rows and t columns, each element of the value vector corresponds to a row of the partition, and s<m and t<n, and
a sequence of one or more column-index vectors, each column-index vector associated with a value vector in the sequence of one or more value vectors and each column-index vector having s elements associated with the s elements of the associated value vector, respectively;
a selection circuit configured to select s elements in parallel from the first register circuitry in response to values of the s elements of and in-process column-index vector of the sequence of one or more column-index vectors;
a plurality of s multiplication circuits configured to generate s products in parallel from the s elements selected from the first register circuitry and the s elements of the value vector associated with the in-process column-index vector; and
a plurality of s accumulation circuits configured to accumulate s sums in parallel from the s products, respectively, wherein each sum of the s sums is a sum of the products generated in response to like-indexed elements in the sequence of one or more value vectors and like-indexed elements in the sequence of column-index vectors.

7. The circuit arrangement of claim 6, wherein s is equal to a number of multiplication operations that can be performed in parallel by a vector processor.

8. The circuit arrangement of claim 6, wherein t=16, wherein values of elements in the column-index vector are hexadecimal values that indicate column indices in the partition of values in corresponding indexed locations in the value vector.

9. The circuit arrangement of claim 8, wherein each column-index vector is a 32-bit word.

10. The circuit arrangement of claim 6, wherein s=8.

11. A circuit arrangement comprising:
a plurality of vector processors configured to multiply a compressed sparse matrix by an input vector having n elements, wherein the compressed sparse matrix represents an m×n sparse matrix and the compressed sparse matrix includes for one or more partitions of a plurality of partitions of the sparse matrix, a respective sequence of one or more value vectors and one or more associated column index vectors, wherein each value vector has s elements of a partition of the plurality of partitions, each column-index vector has s elements associated with the s elements of the associated value vector, respectively, elements of each value vector correspond to rows of the partition, each partition has elements of a group of s rows and t columns of the sparse matrix, and s<m and t<n;
wherein each vector processor is configured to generate in parallel for a partition of the plurality of partitions:
s products of elements of a value vector of the one or more value vectors and elements selected from t elements of the input vector according to column index values in the associated column-index vector of the one or more column-index vectors, wherein each product is associated with a row of the partition, and
s respective partial sums of the products associated with the s rows of the partition; and
wherein for each group of s rows of the sparse matrix, a vector processor of the plurality of vector processors is configured to generate s final sums from the s respective partial sums.

12. The circuit arrangement of claim 11, wherein s is equal to a number of multiplication operations that can be performed in parallel by a vector processor of the plurality of vector processors.

13. The circuit arrangement of claim 12, wherein t=16, and values of elements in the column-index vector are hexadecimal values that indicate column indices in the partition of values in corresponding indexed locations in the value vector.

14. The circuit arrangement of claim 12, wherein each column-index vector is a 32-bit word.

15. The circuit arrangement of claim 12, wherein s=8.

16. The circuit arrangement of claim 12, wherein each vector processor of the plurality of vector processors is configured to generate s products and s respective partial sums from one and only one partition of the plurality of partitions.

17. The circuit arrangement of claim 12, wherein a vector processor of the plurality of vector processors is configured to generate s products and s respective partial sums from two or more partitions of the plurality of partitions.

18. The circuit arrangement of claim 12, wherein a vector processor of the plurality of vector processors is configured to generate s products and s respective partial sums from two or more partitions of the plurality of partitions, and each partition of the two or more partitions covers a subset of rows of the m×n sparse matrix different from a subset of rows covered by each other partition of the two or more partitions.

19. The circuit arrangement of claim 12, wherein a vector processor of the plurality of vector processors is configured to generate s products and s respective partial sums from two or more partitions of the plurality of partitions, and each partition of the two or more partitions covers a subset of columns of the m×n sparse matrix different from a subset of columns covered by each other partition of the two or more partitions.

20. The circuit arrangement of claim 12, wherein a vector processor of the plurality of vector processors is configured to generate s products and s respective partial sums from three or more partitions of the plurality of partitions, a partition of the three or more partitions covers a subset of columns of the m×n sparse matrix different from a subset of columns covered by another partition of the three or more partitions, and a partition of the three or more partitions covers a subset of rows of the m×n sparse matrix different from a subset of rows covered by another partition of the three or more partitions.
